(19) United States
(12) Patent Application Publication
(10) Pub. No.: US 2015/0053543 A1
(43) Pub. Date: Feb. 26, 2015

(54) INTEGRATED CLARIFIER AND FLASH TANK

(71) Applicant: Tongaat Hulett Limited, Tongaat (ZA)

(72) Inventor: Paul Martin Schorn, Sunningdale (ZA)

(21) Appl. No.: 14/372,394

(22) PCT Filed: Jan. 23, 2013
(86) PCT No.: PCT/IB2013/050570

§ 371 Date: Jul. 15, 2014

(30) Foreign Application Priority Data
Jan. 24, 2012 (ZA) 2012/00578

(51) Int. Cl. B01D 3/06

(52) U.S. Cl. CPC B01D 3/06
USPC 202/187

(57) ABSTRACT

This invention relates to an integrated clarifier and flash tank, and more particularly but not exclusively, to an integrated clarifier and flash tank suitable for use in the sugar production process. The integrated clarifier and flash tank includes a clarifier vessel for receiving the liquid to be clarified, and a flash tank arrangement located at least partially inside the clarifier vessel. The clarifier vessel includes a conical bottom that terminates in an outlet for the removal of solids, and at least one liquid outlet towards an upper end zone thereof. The flash tank arrangement has an inlet for receiving a liquid to be clarified, a flashing compartment inside which flashing of the liquid occurs, and an outlet for discharging the liquid to be clarified into the clarifier vessel.

### BACKGROUND TO THE INVENTION

THIS invention relates to an integrated clarifier and flash tank, and more particularly but not exclusively, to an integrated clarifier and flash tank suitable for use in the sugar production process.

In a traditional sugar production process clarification of the juice produced during the extraction process (known as mixed juice) is achieved using a settling clarifier. The clarifier is a vessel in which the suspended solids are settled out after the addition of lime and flocculants.

Prior to the mixed juice entering the clarifier the juice is heated to a temperature of about 3-5° C. above its boiling point in a heat exchanger effectively operating at an elevated pressure, and then allowed to ‘flash’ (rapid boiling resulting from a reduction in pressure) to atmospheric pressure. For example, in a mill at the coast the mixed juice would be heated to between 103-105° C. and then allowed to ‘flash’ to atmospheric pressure prior to the juice being sent to a clarifier. The mixed juice is flashed into a specially designed vessel commonly known as a flash tank.

The reason for this heating and flashing is two-fold:
Entrapped and dissolved air in the juice is allowed to escape from the juice. Any entrapped air will result in the air being released in the clarifier. This air will then rise through the juice, reducing the settling rate of the mud and other particles. This will have a negative effect on the quality of the juice and consequently the final sugar product; and
Flashing to atmospheric pressure ensures that the juice entering the clarifier is always at a constant temperature. Juice pockets of varying temperatures in the clarifier will result in eddy currents within the juice, which will have a negative effect on the settling of the mud particles.

Traditionally the flash tank has been situated external to, and separate from, the clarifier. Disadvantages of this include:
Any overflow from the flash tank will potentially result in injury to any person below the vessel (the juice is at boiling temperature);
Any overflow from the flash tank will potentially result in a loss of juice and therefore sugar product. The juice has low sugar content and as it is at a low pH and high temperature, deteriorates very quickly in floor drains; and
Extra costs are involved in the construction and support of this external vessel.

It is accordingly an object of the invention to provide an integrated clarifier and flash tank that will, at least partially, alleviate the above disadvantages.

It is also an object of the invention to provide an integrated clarifier and flash tank which will be a useful alternative to existing sequential flash tank and clarifier arrangements.

### SUMMARY OF THE INVENTION

According to the invention there is provided an integrated clarifier and flash tank, suitable for use in the sugar manufacturing process, the integrated clarifier and flash tank including:
a clarifier vessel for receiving the liquid to be clarified; the clarifier vessel including a conical bottom that terminates in an outlet for the removal of solids, and at least one liquid outlet towards an upper end zone thereof;
a flash tank arrangement located at least partially inside the clarifier vessel, the flash tank arrangement having an inlet for receiving a liquid to be clarified, a flashing compartment inside which flashing of the liquid occurs, and an outlet for discharging the liquid to be clarified into the clarifier vessel.

There is provided for the flash tank arrangement to comprise an inlet chamber, a connecting passage and a flash chamber.

The inlet chamber is located operatively above the clarifier, and is in the form of an annular chamber in which liquid is introduced in order to facilitate even distribution of the liquid into the flash chamber.

The flashing compartment is located inside the clarifier vessel, and is also in the form of an annular chamber, a base of which defines a distribution plate that aids in distributing liquid radially outwardly.

Outlets are provided at the periphery of the distribution plate, with outlet feeder pipes extending downwardly from the outlets into the clarifier vessel.

Preferably, the outlet feeder pipes extend to a position immediately above a scraper located in the clarifier vessel.

A drive shaft for driving the scraper extends through the center of the annular inlet chamber, annular connecting passage and annular flash chamber of the flash tank arrangement, which are all co-axial with the drive shaft.

### BRIEF DESCRIPTION OF THE DRAWINGS

A preferred embodiment of the invention is described by way of a non-limiting example, and with reference to the accompanying drawings in which:

FIG. 1 is a cut-away perspective view of an integrated clarifier and flash tank in accordance with the invention; and

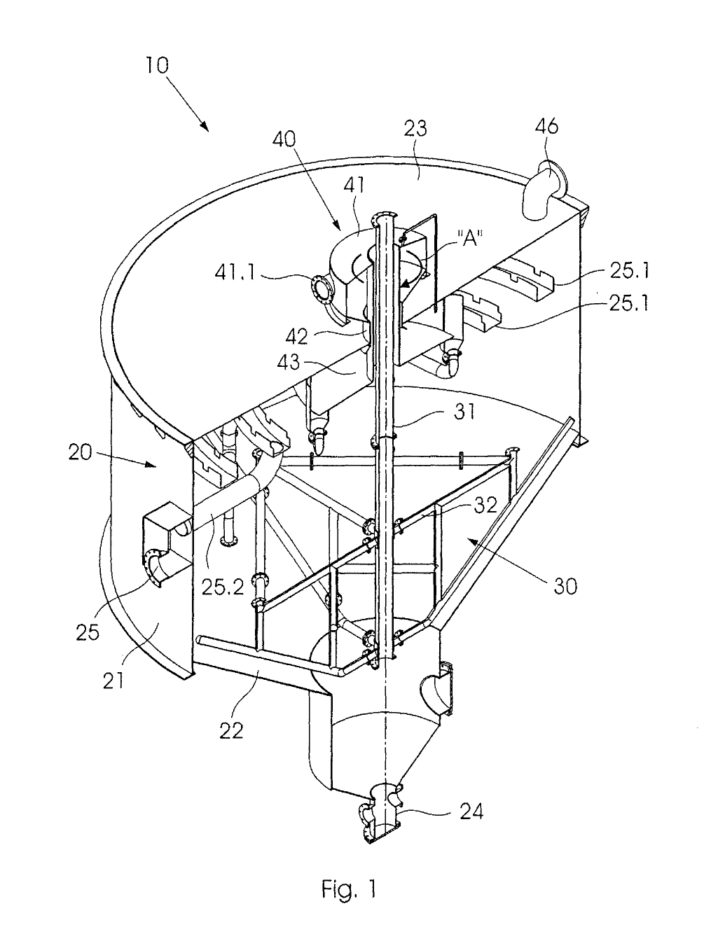

FIG. 2 is a cross-sectional side view showing the flash tank in more detail.

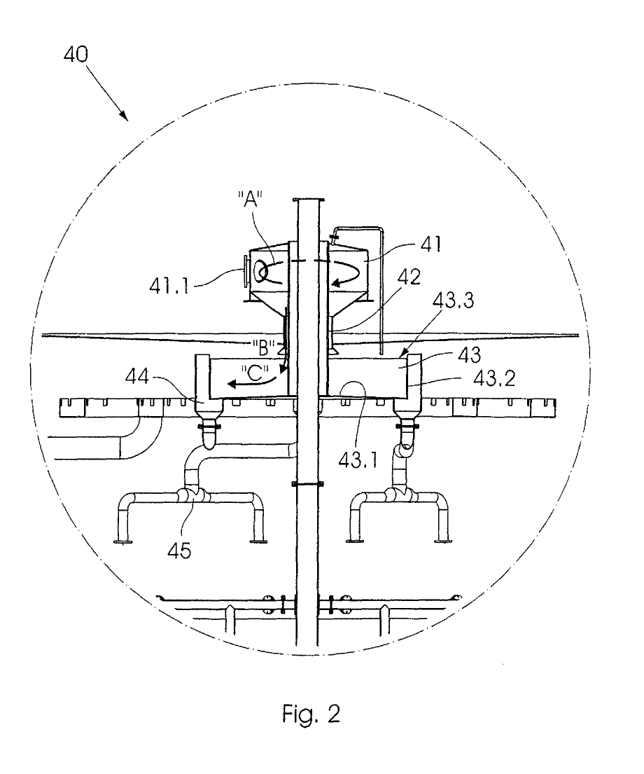

### DETAILED DESCRIPTION OF INVENTION

Referring to the drawings, in which like numerals indicate like features, a non-limiting example of an integrated clarifier and flash tank in accordance with the invention is generally indicated by reference numeral 10. In the description that follows below the generic term “liquid” will be used. However, it should be noted that in a preferred embodiment the liquid is sugar juice.

The integrated clarifier and flash tank 10 comprises a clarifier vessel 20, a rotating scraper 30 provided inside the clarifier vessel 20, and a flash tank 40 located above and partially inside the clarifier vessel 20, but which form an integral structural part of the clarifier vessel 20 even though the functions are still separated.

The clarifier vessel 20 has a cylindrical sidewall 21 which terminates in a conical bottom 22. A solid outlet 24 for removing settled solids and sediment is provided at the bottom of the conical section 22. The clarifier has a slightly concave roof 23, with the inverted apex of the roof directed into the clarifier vessel 20 for reasons that will become apparent later on. A liquid outlet 25 is located towards the upper zone of the cylindrical sidewall 21, and is in flow communication with two concentric overflow launders 25.1 by way of outlet pipes 25.2. The liquid outlet 25 may take many different forms, and may for example also be of a perforated plate design (not shown) without detracting from the gist of the present invention.

The fundamental operating principle of the clarifier vessel is known in the art, and no further detail is required. The new arrangement does, however, result in a number of benefits which will be discussed in more detail below.

A rotating scraper 30 is provided inside the clarifier vessel 20, and comprises a drive shaft 31, which is coaxial with the central axis of the clarifier vessel 20, and scraper blades 32 which are positioned in the conical section 22 of the clarifier vessel.

A flash tank arrangement 40 is provided at the upper end of the clarifier vessel 30, and comprises an inlet chamber 41, a connecting passage 42 and a flash chamber 43. The flash tank arrangement is structurally part of the clarifier vessel, even though the flashing functionality and the clarifying functionality are still separated. As in the case of the clarifier, the basic operation of the flash tank is conceptually similar to that found in the art. However, incorporating the flash tank into the clarifier resulted in a number of unexpected synergies that are discussed in more detail below.

The inlet chamber 41 of the flash tank arrangement is of an annular configuration, with an inlet 41.1 into the inlet chamber being tangential to the inlet chamber 41, so as to define a swirl type chamber. The purpose of the inlet swirl chamber is to ensure that the liquid is evenly distributed and fed into the flash chamber 43.

A connecting passage 42 links the inlet chamber 41 to the flash chamber 43, and is also of annular configuration.

The flash chamber 43 is of a cylindrical, annular configuration, and has cylindrical sidewalls 43.2 and a bottom wall 43.1 which forms a distribution plate that distributes the liquid radially outwardly. The bottom wall 43.1 slopes outwardly downwardly to improve fluid distribution. The upper end 43.3 of the flash chamber 43 is open, which enables flashing of the liquid. Once the liquid has flashed, it flows through outlet ports 44 located at the periphery of the bottom wall 43.1, and enters liquid distribution conduits 45 that distributed the liquid to a zone above the scraper blades 32. Flash from the liquid vents through flash vents 46 in the roof 23.

In this example the flash tank arrangement is designed to accommodate the drive shaft 31 of the scraper 30. More particularly, the annular design of the inlet chamber 41, connecting passage 42 and flash chamber 43 forms a central bore for accommodating the drive shaft 31.

A level of liquid is maintained on the distribution plate by suitable design of the flash chamber outlets or off takes 44 around the edge of the bottom wall or distribution plate 43.1. A level of liquid on the flash plate provides the driving force to allow the liquid to travel down the distributors 45. The level of the settling liquid in the clarifier is determined by the clear liquid off-takes 25. In one embodiment the distribution plate forming the base of the flash chamber/compartment is located above the clear liquid level. However, it is also foreseen that the distribution plate or bottom wall 43.1 may be operatively below the clear liquid level, which means that there will be an increased liquid level inside the flash chamber 43. It is envisaged that this arrangement will prevent air from being entrained in the liquid entering the down takes 44.

The roof 23 of the clarifier vessel 20 is sloped so than any liquid that condenses on the roof of the vessel will be directed to the flash chamber 43. This prevents upsets in the settling zone of the clarifier.

Further advantages of this invention are as follows:
The flash tank is integral to the clarifier which reduces costs of construction, and also minimizes the required installation surface area;
Separate support structures for the external flash tank are not required;
A number of separate flash tanks are not required if there are more than one clarifier in the plant;
Potential for sugar losses is reduced, because the flash tank cannot overflow juice to the ground;
Any overflow of the flash plate is contained within the clarifier;
It is anticipated that overflow of the flash chamber will be minimal due to the increased surface area available on the flash plate in the top of the clarifier; and
There are no juice feed pipes and launders between the flash tank and clarifier which can choke. The filling up of the feed lines from the flash tank can result in the flash tank filling up and overflow.

It will be appreciated that the above is only one embodiment of the invention and that there may be many variations without departing from the spirit and/or the scope of the invention.

1. An integrated clarifier and flash tank, suitable for use in the sugar production process, the integrated clarifier and flash tank including:
a clarifier vessel for receiving the liquid to be clarified; the clarifier vessel including a conical bottom that terminates in an outlet for the removal of solids, and at least one liquid outlet towards an upper end zone thereof; and
a flash tank arrangement located at least partially inside the clarifier vessel, the flash tank arrangement having an inlet for receiving a liquid to be clarified, a flashing compartment inside which flashing of the liquid occurs, and an outlet for discharging the liquid to be clarified into the clarifier vessel.

2. The integrated clarifier and flash tank of claim 1 in which the flash tank arrangement comprises an inlet chamber, a connecting passage and a flash chamber.

3. The integrated clarifier and flash tank of claim 1 in which the flash tank arrangement comprises an inlet chamber, a connecting passage and a flash chamber and in which the inlet chamber is located operatively above the clarifier, and is in the form of an annular chamber in which liquid is introduced in order to facilitate even distribution of the liquid into the flash chamber.

4. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, and in which the flashing compartment is located inside the clarifier vessel, and is in the form of an annular chamber, a base of which defines a distribution plate that aids in distributing liquid radially outwardly.

5. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, in which the flashing compartment is located inside the clarifier vessel, and is in the form of an annular chamber, a base of which defines a distribution plate that aids in distributing liquid radially outwardly, and in which outlets are provided at the periphery of the distribution plate, with outlet feeder pipes extending downwardly from the outlets into the clarifier vessel.

6. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, in which the flashing compartment is located inside the clarifier vessel, and is in the form of an annular chamber, a base of which defines a distribution plate that aids in distributing liquid radially outwardly, in which outlets are provided at the periphery of the distribution plate, with outlet feeder pipes extending downwardly from the outlets into the clarifier vessel, and in which the distribution plate is located below a level of liquid inside the clarifier.

7. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, in which the flashing compartment is located inside the clarifier vessel, and is in the form of an annular chamber, a base of which defines a distribution plate that aids in distributing liquid radially outwardly, in which outlets are provided at the periphery of the distribution plate, with outlet feeder pipes extending downwardly from the outlets into the clarifier vessel, in which the distribution plate is located below a level of liquid inside the clarifier, and in which the distribution plate is located below the level of the liquid outlet of the clarifier.

8. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, in which the flashing compartment is located inside the clarifier vessel, and is in the form of an annular chamber, a base of which defines a distribution plate that aids in distributing liquid radially outwardly, in which outlets are provided at the periphery of the distribution plate, with outlet feeder pipes extending downwardly from the outlets into the clarifier vessel, in which the distribution plate is located below a level of liquid inside the clarifier, in which the distribution plate is located below the level of the liquid outlet of the clarifier, and in which the outlet feeder pipes extend to a position immediately above a scraper located in the clarifier vessel.

9. The integrated clarifier and flash tank of claim 1 in which the flash tank arrangement comprises an inlet chamber, a connecting passage and a flash chamber, in which the inlet chamber is located operatively above the clarifier, and is in the form of an annular chamber in which liquid is introduced in order to facilitate even distribution of the liquid into the flash chamber, in which the flashing compartment is located inside the clarifier vessel, and is in the form of an annular chamber, a base of which defines a distribution plate that aids in distributing liquid radially outwardly, in which outlets are provided at the periphery of the distribution plate, with outlet feeder pipes extending downwardly from the outlets into the clarifier vessel, in which the distribution plate is located below a level of liquid inside the clarifier, in which the distribution plate is located below the level of the liquid outlet of the clarifier, in which the outlet feeder pipes extend to a position immediately above a scraper located in the clarifier vessel, and in which a drive shaft for driving the scraper extends through the center of the annular inlet chamber, annular connecting passage and annular flash chamber of the flash tank arrangement, which are all co-axial with the drive shaft.

10. The integrated clarifier and flash tank of claim 1 substantially as herein described with reference to the accompanying figures.
